(19) United States
(12) Patent Application Publication
(10) Pub. No.: US 2005/0138324 A1
(43) Pub. Date: Jun. 23, 2005

(54) PROCESSING UNIT HAVING A DUAL CHANNEL BUS ARCHITECTURE

(75) Inventors: Pascal Tannhof, Fontainebleau (FR); Jan Slyfield, San Jose, CA (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 10/905,100

(22) Filed: Dec. 15, 2004

(30) Foreign Application Priority Data
Dec. 19, 2003 (FR) 03368122.2

(51) Int. Cl. G06F 15/00

(52) U.S. Cl. 712/10

(57) ABSTRACT

A processing unit having a dual channel bus architecture associated with a specific instruction set, configured to receive an input message and transmit an output message that is identical or derived therefrom. A message consists of one opcode, with or without associated data, used to control each processing unit depending on logic conditions stored in dedicated registers in each unit. Processing units are serially connected but can work simultaneously for a total pipelined operation. This dual architecture is organized around two channels labeled Channel 1 and Channel 2. Channel 1 mainly transmits an input message to all units while Channel 2 mainly transmits the results after processing in a unit as an output message. Depending on the logic conditions, an input message not processed in a processing unit may be transmitted to the next one without any change.

### FIELD OF THE INVENTION

The present invention relates to data processing, and more particularly to an improved processing unit having a dual channel bus architecture that allows a serial transmission of data from a host computer to a very large number of such processing units and their parallel processing for a totally pipelined operation. The present invention can find extensive applications in pattern recognition systems.

### BACKGROUND OF THE INVENTION

To recognize specific patterns within a set of data is important in many fields, including speech and pattern recognition, image processing, seismic data analysis, etc.. If the real-time data processing is too intensive for one processing unit (PU), then several PUs can be used in parallel to increase the computational power. For real-time applications, existing hardware solutions have some major limitations concerning scalability and input/output bandwidth. For instance, in the field of pattern recognition, a typical application of parallel computation is the pattern matching. In this case, the incoming data stream consists of a set of input patterns that are sent by a host computer to all the PUs of a system (note that every PU is identified by its identification number, ID in short). Then, each PU compares the input pattern with the reference pattern (also referred to as a prototype) stored therein. Depending on the application, several operating modes can be used to perform this comparison usually referred to as the Exact, Longest, Maximum, and Fuzzy modes.

Exact Matching (EM) mode can be used for aligned or nonaligned data and can incorporate regular expression comparisons. Exact matching mode can also be used in applications such as network intrusion where line speed matching is critical and a binary “match” or “not match” response is only needed.

Longest Matching (LM) mode is used to find the data with the maximum number of bytes that sequentially match, allowing thereby to keep track of the number of consecutive matches in the incoming data stream.

Maximum Matching (MM) mode is used to keep track of the number of matched bytes. In this mode, each PU determines the total number of matched bytes.

Finally, the Fuzzy Matching (FM) mode computes the similarity degree between an input pattern and all the reference patterns stored in a library. In this mode, each PU is searching for the closest reference pattern and then it outputs its ID and the distance it has found. This mode is very useful in image processing and real time data processing.

In all the above modes, an input pattern is sent to all PUs, then each PU thus compares this input pattern to the reference pattern stored therein, and once all comparisons have been performed in all the PUs of the system, the results are sent to the host computer.

FIG. 1 shows a conventional system 10 basically comprised of four identical PUs 11-1 to 11-4, a control & interface (CI) circuit 12 and a host computer 13 forming a typical implementation of parallel processing. Each PU receives input data and control signals via an input bus 14. For the sake of illustration, let us consider PU 11-1. It schematically consists of a computation circuit 15-1 connected to an address circuit 16-1 and a memory 17-1 via bi-directional buses. Computation circuit 15-1 includes registers (status, cache, ID, . . . ) and memory 17-1 stores the data and corresponding instructions as standard. After processing data in computation circuit 15-1, the data representing the results are sent on a bus referenced 18-1. Output bus 18 collects all individual buses 18-1 to 18-4 by a global OR dotting function (shown in FIG. 2). Input and output buses 1 3 and 18 ensure adequate data exchange between the PUs 11-1 to 11-4 and the host computer 13 via the CI circuit 12 as standard. At each clock cycle, new data can be sent and broadcast to all PUs. For real-time applications, an important metric is the computation performance, the number of input patterns that can be processed per second relative to the number of desired reference patterns. This simple parallel architecture can satisfactorily operate, but only with a few number of PUs, four in the illustrated case but a dozen in reality, because it has some major limitations in terms of speed and scalability if more PUs are added in order to increase the performance of the system 10.

The first cause of these limitations is due to the wiring. If the number of PUs is important, buffers must be added in order to re-drive the signal which transmits the incoming data stream on input bus 14. In this case, the number of PUs in each block can be significantly increased for instance, up to a few hundreds instead of the dozen mentioned above. FIG. 2 shows such a system referenced 19 which derives from system 10 of FIG. 1 in some respects.

Now turning to FIG. 2, system 19 is still comprised of control & interface circuit 12, host computer 13, but now the number of PUs has been extended to m, referenced 11-1 to 11-m, wherein m can be in the range of a few hundreds. Input bus 14 still transports the input data and opcodes that are necessary to control the operation of PUs. For increased performance, a buffer block 20 has been added to re-drive signals transported on the input bus 14 before they are applied to the computation circuits 15-1 to 15-m. Buffer block 20 is formed by a tree of elementary buffers. If, as illustrated in FIG. 1, the results output by the PUs were directly applied on the output bus, this implementation would be operative but would still have some significant drawbacks when the number of PUs further increases. In particular, the delay to send the input data to all PUs would be very important. As a result, because it is difficult to balance exactly all wires since CI circuit 12 must wait a result on bus 24 before emitting a signal on bus 14, the clock cycle should be reduced. Still another speed limitation would be due to the wiring in the output bus because system 19 shown in FIG. 2 is provided with a specific logic circuitry, including the OR dotting function mentioned above to overcome these inconveniences when the number of PUs is very high. To that end, each PU is first provided with a two-way AND gate. For example, the result that is output by the computation circuit 15-1 in PU 11-1, is applied on a first input of an AND gate 21-1 and a signal SELECT sent by the internal control logic of PU 11-1 (not shown) is applied on the second input thereof. The m AND gates 21-1 to 21-m form AND block 21. The output of AND gate 20-1 is applied to a m-way OR gate 22 via bus 23-1. In reality, OR gate 22 is built with a tree of elementary OR gates depending on their fan-in capabilities. Finally, the output of OR gate 22 is connected to the interface circuit 12 via output bus 24. Buffer block 20, PUs 11-1 to 11-m, AND gates 21-1 to 21-m, m-way OR gate 22 and control & interface circuit 12 are generally integrated in a semiconductor chip represented by reference 25 (on-chip system). Note that terminals 26a and 26b allow an external access of chip 25 to and from host computer 13 respectively. The implementation depicted in FIG. 2 results in large delays on the output bus, caused by the trees forming blocks 20 and 22, and therefore reduced output time. Large delays on the output bus imply to reduce the input data transmission frequency, to avoid some data contention thereon. Moreover, it is to be noted that said trees in blocks 20 and 22 also increase the area needed to implement such an architecture in hardware which in turn, reduce the processing speed and limit the scalability.

In addition, before writing in the memory of a specific PU, this PU must be selected and this selection takes one clock cycle each time data must be written in another PU. On the other hand, a performance limitation is due to some data contention that can occur on the input and output buses. A first data contention can occur on the input bus when data have to be written in a memory. But the most important data contention occurs on the output bus during the comparison phase. For instance, in an application to pattern recognition, each PU compares the input pattern with its own stored reference pattern. When the comparison is completed, it is necessary to know all distances between the input pattern and the reference patterns stored in the PUs, and because, all PUs are using the same output bus to send the result, the outputting phase can take a long time.

This point is illustrated in conjunction with FIG. 3 which shows several frames representing the timing corresponding to system 18 of FIG. 2 operating in the Exact Matching mode at several times. A sequence of input data, labeled Data 1, Data 2, . . . is applied to the PUs of system 19. As apparent in FIG. 3, the PUs, i.e. PU#2 and PU#1, for which the input data matches the reference data stored therein, send their Ids in sequence to the output bus 24. Because the output bus 24 is connected to thousands of PUs 11 via the tree of OR gates in block 22, it runs much more slower than the PUs. Consequently, as apparent in FIG. 3, because the output delay time takes more than one clock cycle, the output bus is busy most of the time. For instance, if Data 4 matches PU#3, the transmission of the ID of PU#3 will be delayed until completion of PU#2 ID transmission. It does also exist a limitation directly related to the scaling capability. In order to increase the power computation of system 19 which includes a few thousands of PUs integrated in a semiconductor chip, an usual solution is to mount several identical chips onto an electronic card.

FIG. 4 shows such an implementation referenced 27 which includes a number r of such chips 25-1 to 25-r. If the number of chips is important, some re-drive devices are again needed. As a result, a buffer block 28 is interposed between the interface circuit now referenced 12′ and all the input buses 14-1 to 14-r to properly drive the chips. On the other hand, a second re-drive device 29, typically a r-way OR gate (in reality a tree of OR gates as mentioned above), receives all the output buses 24-1 to 24-r and has its output connected to interface circuit 12′. The CI circuit 12 drives the buffer block 28 via input bus 30 and is connected to OR gate 29 via output bus 31. Buffer block 28, chips 25-1 to 25-r, OR gate 29 and CI circuit 12′ represent an electronic card 33 having a capability of thousands PUs. In this case, the global wiring is very important and, as a consequence, the speed of the whole system 27 is decreased. The above problem related to card 33 design, is also present for the ASIC chip 25 design, as it is sometimes difficult to make an efficient floor planning placement, and the wiring is complex due to the many global signals that are distributed to all PUs. Note that terminals 32a and 32b allow an external access of card 33 to and from host computer 13 respectively.

Therefore, there is a need for a method and a system to overcome all these limitations and inconveniences resulting therefrom.

### SUMMARY OF THE INVENTION

The present invention addresses the above-described need by providing a processing unit having a dual channel bus architecture that allows improved performance and scalability. This architecture permits considerable expansion of the number of PUs without requiring a significant increase in circuit wiring and without any degradation in processing speed. At the cost of a very slightly increasing the circuit complexity of PUs, the need for external circuitry to merge a considerable number of PUs together is avoided.

In addition, the processing unit of the present invention permits a reduction in the amount of re-drive devices necessary to distribute the input data and to collect the output data, i.e. the results.

Furthermore, the architecture of the processing unit of the present invention permits a regular circuit floor planning placement at the chip and card level; reduces power dissipation; and allows a total pipelined operation.

According to the present invention there is described an improved processing unit (IPU) having a dual channel bus architecture associated to a specific instruction set configured to receive an input message and transmit an output message that is identical or derived therefrom. A message consists of one opcode with or without associated data that are used to control each IPU depending on logic conditions stored in dedicated registers in each IPU. IPUs are serially connected but can work simultaneously for a total pipelined operation. This dual architecture is organized around two channels labeled Channel 1 and Channel 2. Channel 1 mainly transmits an input message to all IPUs while Channel 2 mainly transmits the results after processing in an IPU as an output message. Depending on said logic conditions, an input message not processed in an IPU can be transmitted to the next one without any change.

With this architecture, scaling is accomplished by increasing the number of IPUs without increasing system complexity. Increasing the number of IPUs requires only local connections without requiring additional circuitry outside the IPUs.

The present invention also concerns a method of processing a message consisting of and opcode with or without associated data comprising the steps in a system based on said dual channel bus architecture.

The novel features believed to be characteristic of this invention are set forth in the appended claims. The invention itself, however, as well as other objects and advantages thereof, may be best understood by reference to the following detailed description of an illustrated preferred embodiment to be read in conjunction with the accompanying drawings.

### BRIEF DESCRIPTION OF THE DRAWINGS

FIG. 1 shows a conventional system implementing parallel processing with four processing units (PUs).

FIG. 2 shows the system of FIG. 1 in more details and further provided with a logic circuitry to increase performance, all elements thereof (except the host computer) can be integrated in a semiconductor ASIC chip.

FIG. 3 shows the timing corresponding to the system of FIG. 2 operating in the Exact Matching mode at several times.

FIG. 4 shows the design of an electronic card on which a plurality of the semiconductor ASIC chips of FIG. 2 can be mounted.

FIG. 5A shows a system with a plurality of improved processing unit (IPU) having a dual channel bus architecture according to the present invention implemented with two single channel control circuits and a process condition circuit.

FIG. 5B shows a variant to the system of FIG. 5A implemented with a double channel control circuit.

FIG. 6 shows the algorithm at the base of the method of the present invention to explain the message processing performed by each IPU.

FIG. 7A shows an hardware implementation of the single channel control/process condition circuit combination in the system depicted in FIG. 5A.

FIG. 7B shows the hardware implementation of the double channel control circuit in the system depicted in FIG. 5B.

FIG. 8 illustrates the loading of some data in each IPU.

FIG. 9 still illustrates the reading of some data in each IPU, but in another way.

FIG. 10 illustrates the reading of four values contained in four IPUs.

FIG. 11 shows the timing when a Exact Matching mode is used.

FIG. 12 shows the floor planning of semiconductor ASIC chip built with IPUs of the present invention wherein all IPUs form a chain.

FIG. 13 shows the floor planning of an electronic card built with semiconductor ASIC chips of FIG. 12 wherein all chips form a chain for comparison purposes with the electronic card depicted in FIG. 4.

### DETAILED DESCRIPTION OF PREFERRED EMBODIMENTS OF THE INVENTION

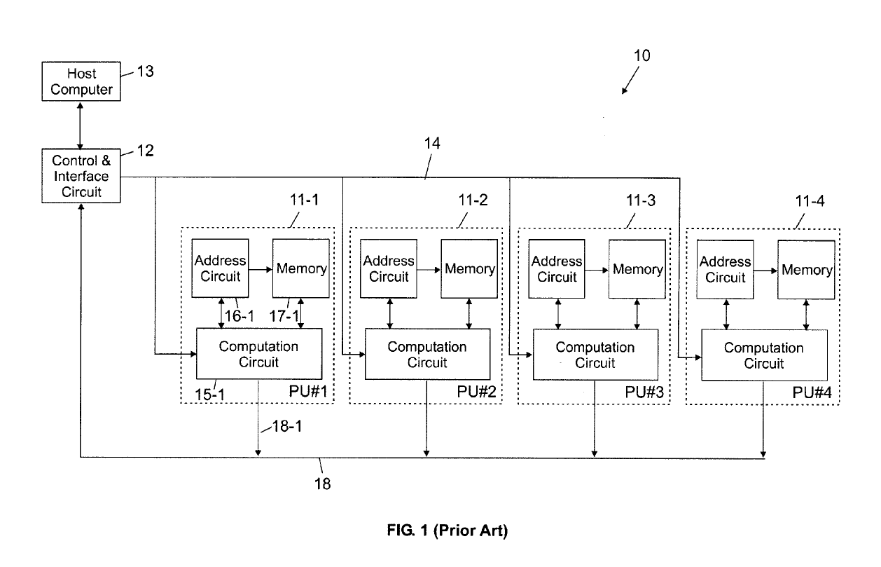

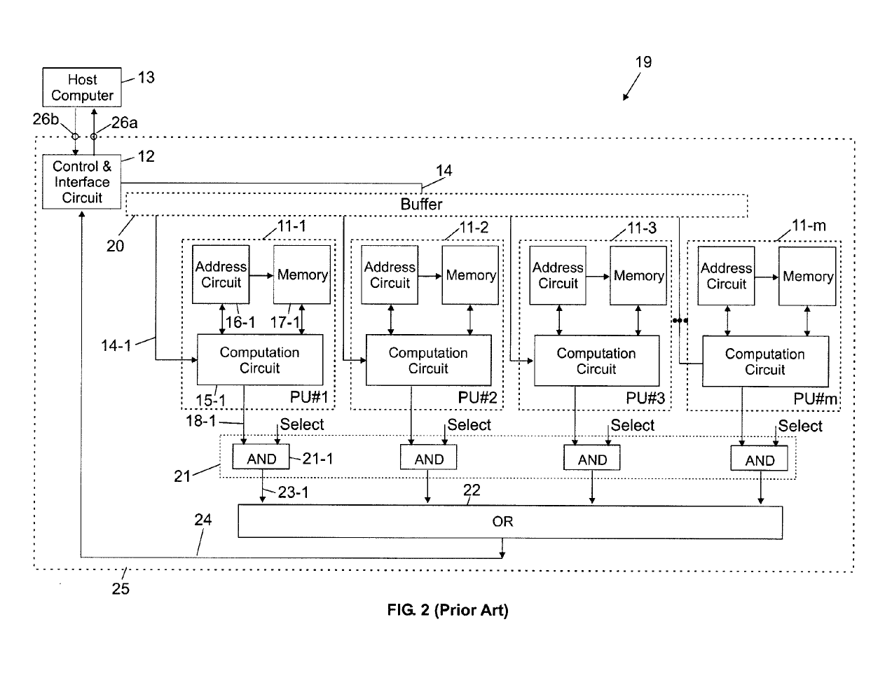

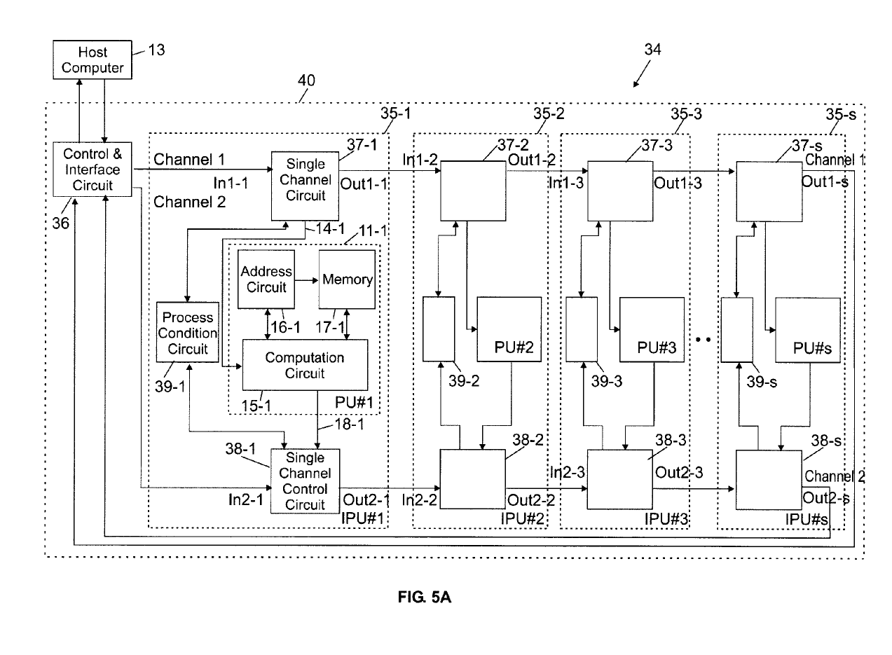

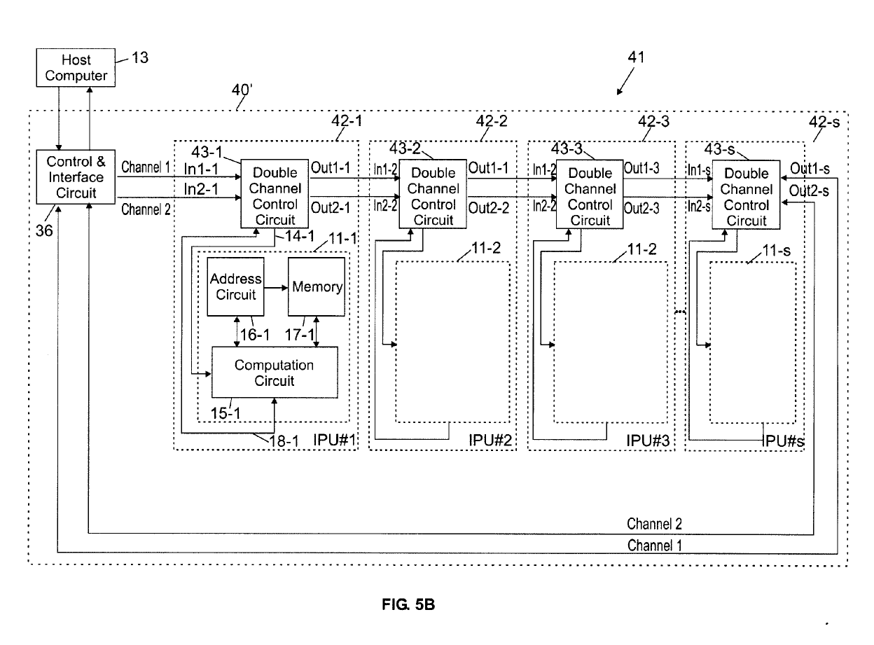

FIG. 5A shows a system comprised of a plurality of improved processing units (IPUs) having a dual channel bus architecture according to the present invention. FIG. 5B shows a variant of the FIG. 5A system. Now turning to FIG. 5A, the system referenced 34 includes a number s of IPUs, referenced 35-1 to 35-s, a control & interface circuit (CI) circuit now referenced 36 because it can have a structure slightly different of the conventional CI circuits 12 and 12′ previously shown, and the host computer 13 as standard. Each IPU is organized around the conventional PU (generically referenced 11 in FIGS. 1 and 2) and further includes a pair of single channel control (SCC) circuits and a process condition (PC) circuit. Let us consider IPU 35-2 for the sake of illustration. The upper SCC circuit 37-2 has a serial connection with the corresponding SCC circuits 37-1 and 37-3 of the previous and next IPUs 35-1 and 35-3. This type of connection applies to each IPU, except for the first IPU 35-1 and the last IPU 35-s, which are connected to the CI circuit 36 (and then to the host computer) on one side. As a whole, this connection is referred to hereinbelow as Channel 1. Similarly, the lower SCC circuit 38-2 has a serial connection with the corresponding SCC circuits 38-1 and 38-3 of the previous and next IPUs 35-1 and 35-3. This type of connection still applies to each IPU, except the first IPU 35-1 and the last IPU 35-s, which are connected to the CI circuit 36 on one side. As a whole, this connection is referred to hereinbelow as Channel 2. These connections Channel 1 and Channel 2 are an essential feature of the dual channel bus architecture of the present invention and will be described later on in more detail. Referring to IPU 35-1 for details of an IPU, SCC circuit 37-1 has a connection with the computation circuit 15-1 via bus 14-1, and the output of the computation circuit 15-1 is connected to SCC circuit 38-1 via bus 18-1. PC 39-1 plays the role of an interface between SCC circuits 37-1 and 38-1 via two specific bi-directional buses. The process control circuit includes flag registers (write_flag, read_flag, . . . ), the role of which will be explained later, that determine the operation of the IPU. An IPU, e.g. 35-1, is thus formed by the combination of a conventional PU, e.g. 11-1, the two SCC circuits associated therewith, i.e. 37-1 and 38-1, and PC circuit 39-1. Input terminals In1-q and In2-q (where q is a number from 2 to s) to SCC circuits 37-q and 38-q allow a serial connection to the previous corresponding SCC circuit. On the other hand, output terminals Out1-r and Out2-r (where r is a number from 1 to (s-1)) allow a serial connection to the next corresponding SCC circuit. Input terminals In1-1 and In2-1 and output terminals Out1-s and Out2-s are connected to the CI circuit 36 via Channel 1 or Channel 2 respectively, to terminate the connecting loop arrangement depicted in FIG. 5A. Finally, it is noteworthy that IPUs 35-1 to 35-s and CI circuit 36 can be integrated in a semiconductor ASIC chip referenced 40.

FIG. 5B (in which identical elements bear identical references) shows a variant of system 34, referenced 41, wherein the SCC and PC circuits have been merged in one double channel control (DCC) circuit. Turning to FIG. 5B, system 41 still includes a number s of IPUs, but now referenced 42-1 to 42-s, control & interface circuit (CI) circuit 36 and the host computer 13. Each IPU now consists of the conventional PU 11 and a DCC circuit which results of the above mentioned merge. Let us consider IPU 42-2 for example, it includes PU 11-2 and DCC circuit 43-2 wherein input bus 14-2 and output bus 18-2 ensure the IN and OUT connections with the computation circuit 15-2 as described above. Input and output terminals In1-2, In2-2 and Out1-2, Out2-2 allow the two serial Channel 1 and Channel 2 connections with the previous and the next DCC circuits 43-1 and 43-3 respectively. On the other hand, input terminals In1-1/In2-1 and output terminals Out1-s, Out2-s are still connected to the CI circuit 36 to terminate the connecting loop arrangement depicted in FIG. 5B. It is noteworthy that the combination of IPUs 43-1 to 43-s and CI circuit 36 can also be integrated in a semiconductor ASIC chip referenced 40′.

Channel 1 is mainly used to send a continuous data stream to all IPUs. On the other hand, Channel 2 is mainly used to get/transmit results while Channel 1 transmits input data and IPUs perform computations on that input data. It is to be noted that in view of the symmetrical and flexible architecture of systems 34 and 41, Channel 1 can be used to get data and Channel 2 to send data as well.

However, it should be understood that the dual channel bus architecture depicted in FIGS. 5A & 5B can be applied to other types of elementary processing units or processors. In summary, the improved processing unit (IPU) of the present invention is constructed around any conventional processing unit (PU) but includes some additional circuitry, the SSC and PC circuits on the one hand, and the DCC circuits on the other hand. All IPUs are connected in a serial fashion but can work simultaneously in order to build a chain for total pipelined operation. Basically, the operation of systems 34/31 may be understood as follows. The above-mentioned additional circuitry is configured to receive, process and send “messages”. The term “message” is used herein to refer to an opcode, possibly associated with data. An IPU receives a message from the previous IPU (except for the first IPU which is connected to the host computer via the CI circuit 36). This IPU processes the message and can send one message to the next IPU (two messages can be sent if both channels are used), except the last IPU, which is connected to the host computer, still via the CI circuit 36. The opcode and the data are sent from one IPU to another IPU using either channel or both channels if so required. Two channels are therefore required to implement this architecture, such as described by reference to FIGS. 5A & 5B. A specific instruction set, described later, is used to build the messages to be decoded in each IPU.

Each IPU uses a process condition in order to determine if the message must be processed or just transmitted to the next IPU. It is useful to have at least the two following flags as a process condition. One flag labeled “write_flag” is used to determine the process condition in a write operation and the other flag labeled “read_flag” is used to determine the process condition in a read operation (these flags can be merged in one single flag). Other flags can be used depending upon the application.

According to the present invention, messages, depending on the opcode they contain, can be classified in several types:
(1) “Write (W)” and “Write All (WA)”: this type of messages is used to write data in dedicated registers in one specific IPU or in all IPUs. Depending on the data length and the internal IPU architecture, either channel or both channels (if there are two moessages) can be used. Because these messages are only used to write data into one or all IPUs, an IPU does not generate any new message in response thereto. In the case where the process condition is verified, there are two possibilities for the IPU: either transmitting the same message (if the same data is to be written in all IPUs) or no transmission, if the data has been written in the IPU. If the IPU does not match with the process condition, the message is transmitted to the next IPU.
(2) “Read (R)” and “Read All (RA)”: this type of messages is used to read data from the dedicated registers in a specific IPU or in all IPUs. Depending of the data length and the internal IPU architecture, either Channel 1 or Channel 2 is used. These messages are always subject to a process condition. If the process condition is verified, a new message is generated and sent on the same channel or using the other channel depending on the internal IPU architecture and the bus width for both channels. This type of message always generates a Transmit type of message.
(3) “Transmit (T)”: this type of message is only used to transmit directly data from one IPU to the host computer through all the following IPUs. In fact, these messages are a specific case of the Write type of messages which write data only if a process condition is verified.

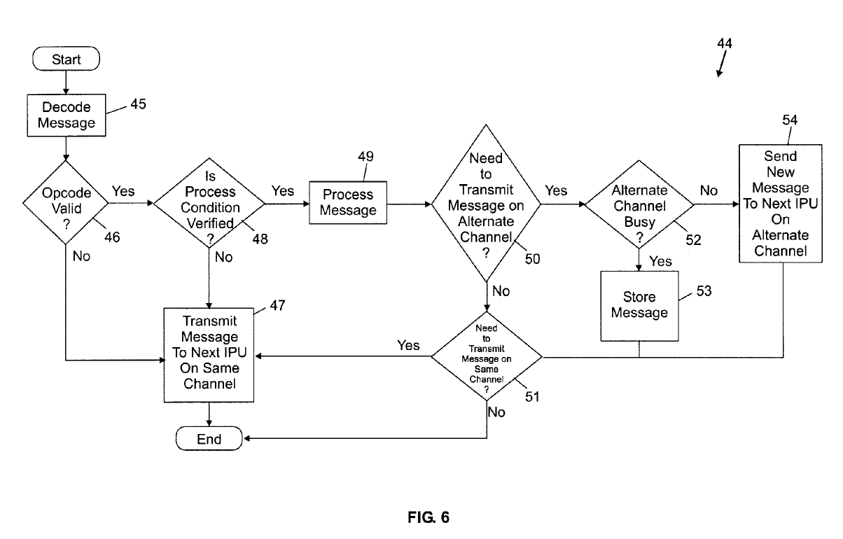

FIG. 6 shows the algorithm, referenced 44, at the base of the method of the present invention to explain the message processing that is performed by each IPU. The opcode included in the input message is first decoded (box 45), then a test is performed (box 46). If the opcode is not valid, i.e. known by the IPU, the whole message is transmitted to the next IPU without any modification (box 47), i.e. same opcode and same data on the same channel (e.g. Channel 1). If the opcode is valid, the process condition is then examined to determine if the process condition is verified, i.e. if it matches (box 48). The process condition can be any condition based on a determined value stored in a dedicated register. For example, if this dedicated register holds a ‘1’, the process condition is said “match”. If this process condition is not verified, the message is transmitted to the next IPU on the same channel (box 47). In the other case, i.e. the process condition is verified, the message is processed (box 49), i.e. data/opcodes are extracted and tasks performed. Then, the need of transmitting on the alternate channel (i.e. Channel 2) is tested (box 50). If No, the need of transmitting on the same channel is tested (box 51). If this need exists, the process loops to box 47 and the message is transmitted on the same channel (i.e. Channel 1) and in the contrary, the process stops. Now, if in box 50 the answer is Yes, the alternate channel is tested in box 52 to determine if it is busy or not. If it is busy, the message is stored (box 53) and the need of transmitting the message on the said same channel is tested in box 51. If is not busy, the new message is sent (box 54) on the alternate channel (i.e. Channel 2), but as apparent in FIG. 6, the process then loops to box 51 to determine whether another message has to be sent on the said same channel (i.e. Channel 1), in this case both channels are used to send two different messages.

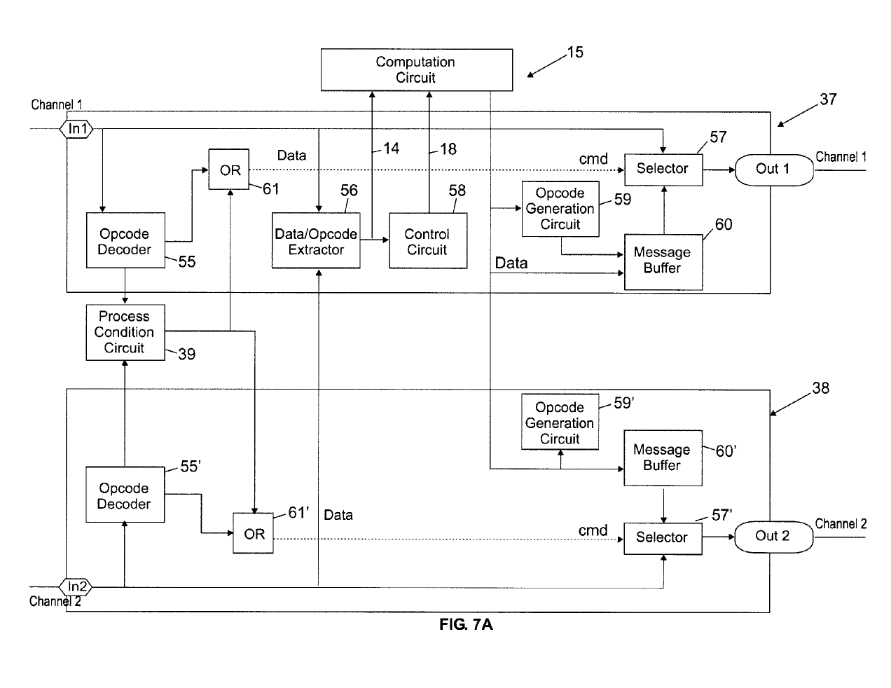

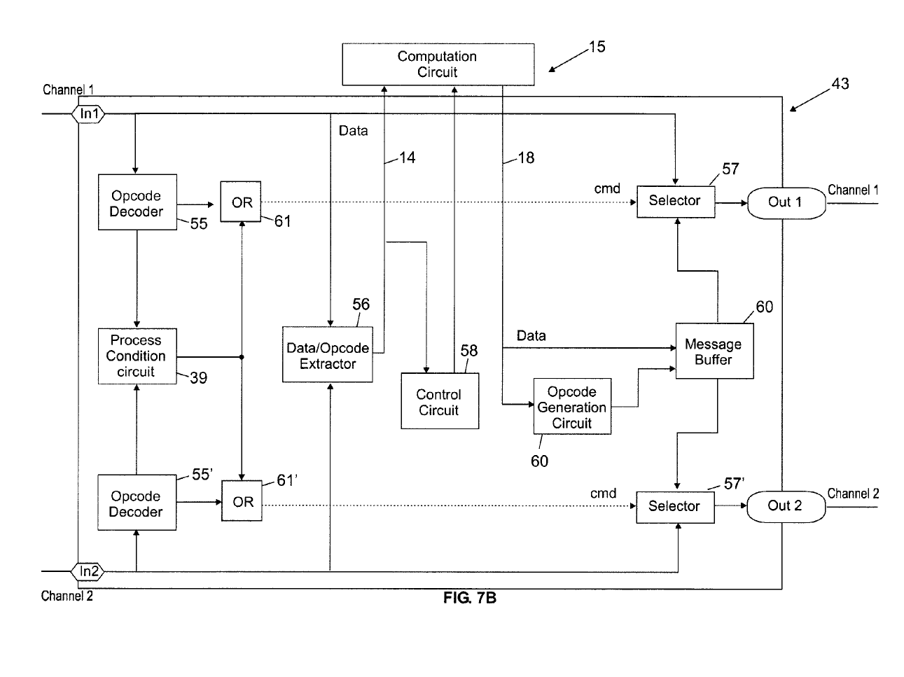

FIG. 7A shows a possible hardware implementation of the single channel control/process condition circuit combination depicted in FIG. 5A, i.e. of SCC circuits 37 and 38 and PC circuit 39. SCC circuit 37 (which relates to Channel 1) has input and output terminals In1 and Out1 connected to buses referred to as Channel 1. Similarly, SCC circuit 38 has input and output terminals In2 and Out2 connected to buses referred to as Channel 2. To input terminal In1 are connected opcode decoder 55 that decodes the opcodes, data/opcode extractor 56 that extracts data and opcodes of both Channel 1 and Channel 2 (via input terminal In2) and finally two-way selector 57. Data/opcodes output by extractor 56 are applied to control circuit 58 that controls the overall operation and to computation circuit 15 via bus 14. Data/opcodes generated by computation circuit 15 are applied to opcode generation circuit 59 and message buffer 60 via bus 18. Opcode decoder 55 drives the process condition circuit 39 and has an output connected to a first input of two-way OR gate 61. The latter receives the signal generated by process condition circuit 39 on its second input. The signal output from OR gate 61 is applied on the command input Cmd of selector 57. The role of selector 57 is just to transmit the input message or the message stored in buffer 60. For instance, if the output of opcode decoder 55 is at ‘0’, this means that the opcode has been properly decoded, then if the output of process condition circuit is also ‘0’, the output of OR gate is ‘0’ so that the selector 57 allows transmission of the new message stored in message buffer 60. Now, if the output of opcode decoder 55 is at 1, this means that the opcode has not been decoded, so that selector 57 sends the input message as the output message without any change. As apparent in FIG. 7A, SCC circuit 38 (which relates to Channel 2) is identical to SCC circuit 37 except in that it does not include circuits 56 and 58.

FIG. 7B shows a possible hardware implementation of the DCC circuit depicted in FIG. 5B that is directly derived from the FIG. 7A single channel control/process condition circuit combination. However, because circuits 59′ and 60′ are saved in this implementation, this implementation is more rational and more economical.

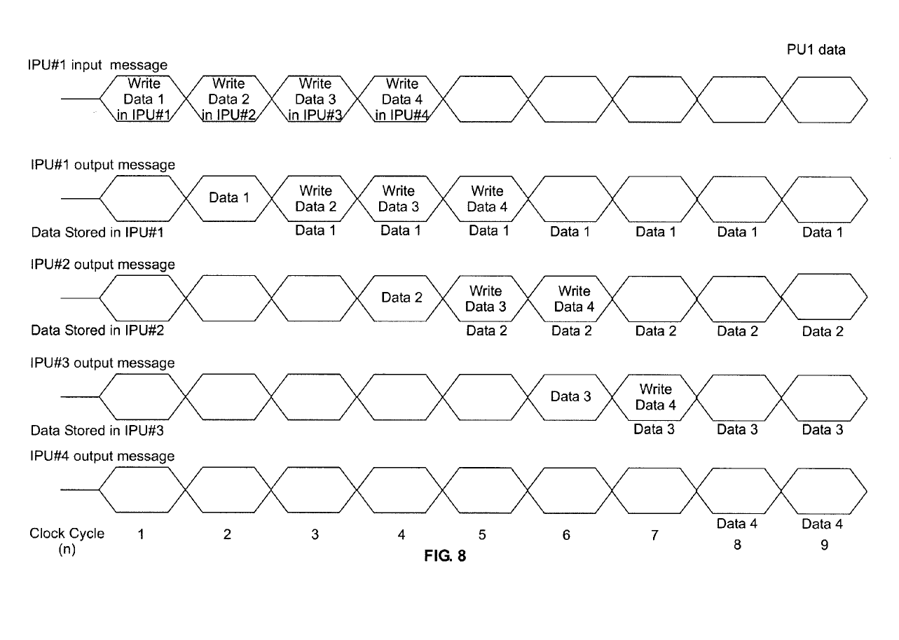

FIG. 8 illustrates how to write four data (Data 1 to Data 4) in four IPUs (IPU#1 to IPU#4) respectively in a time interval given by n=8 clock cycles. These IPUs are those of systems 34 and 41 depicted in FIGS. 5A & 5B. After eight clock cycles, all these data are written. Only four clock cycles are needed to present these four data to IPU#1 as an input message. At the second clock cycle, because its write_flag is set to ‘0’, Data 1 is processed (i.e. stored in IPU#1) and write_flag is set to ‘1’. One clock cycle later, the message Write Data 2 is presented to IPU#1 which outputs this Write Data 2 message (which becomes IPU#2 input message), while Data 1 is stored in IPU#1, and so on.

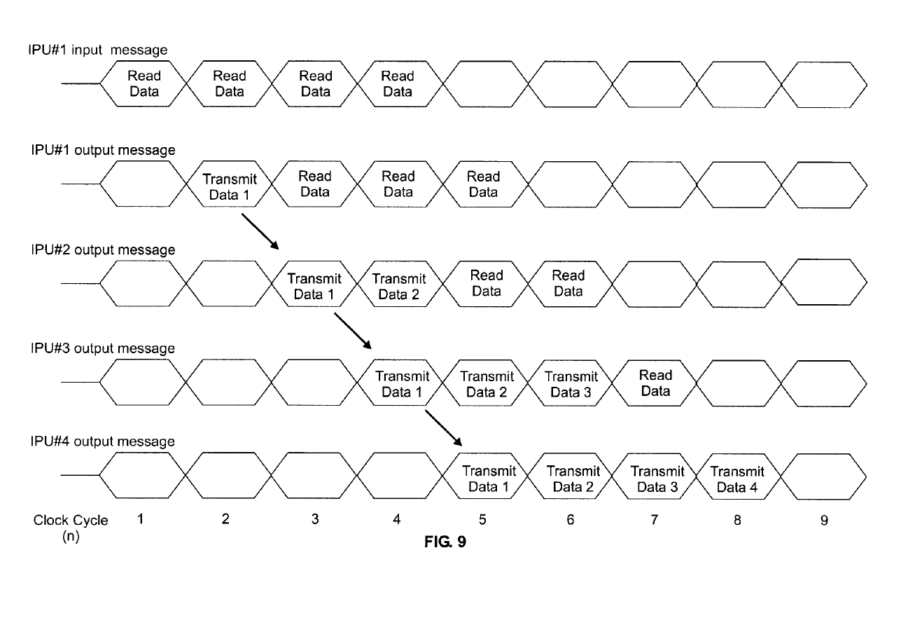

FIG. 9 illustrates how to read data still in four IPUs for the sake of simplicity. A Read type message is sent to the first IPU of the chain; if IPU#1 has not already read (read_flag=‘0’), the Read message is processed, IPU#1 sets the read_flag to ‘1’ and sends a specific Transmit message to IPU#2, because a Transmit message is always transmitted to the next IPU. The data sent by IPU#1 is therefore transmitted to IPU#4 via IPU#2 and IPU#3 and finally to the host computer. To read the second IPU, the same Read message can be sent immediately after the first message, because IPU#1 has now its read_flag set to ‘1’. The message is transmitted to IPU#2, the read_flag of which being set to ‘0’ is allowed to process and transmit the message, and so on. As a result, at each clock cycle, a new IPU can be read. Results are thus sent in sequence through the remaining IPUs of the chain.

The table below summarizes the basic operations:

Input message type Action Output message type

Write

if write_flag = 0 store data and set write_flag=1 - if
write_flag = 1 - Write

(same message)

Read

if read-flag = 0 read data and set read_flag=1 Transmit if
read_flag = 1 - Read

(same message)

Transmit - Transmit

(same message)

Note that derived unconditional opcodes, e.g. Write Always, can
be envisioned as well.

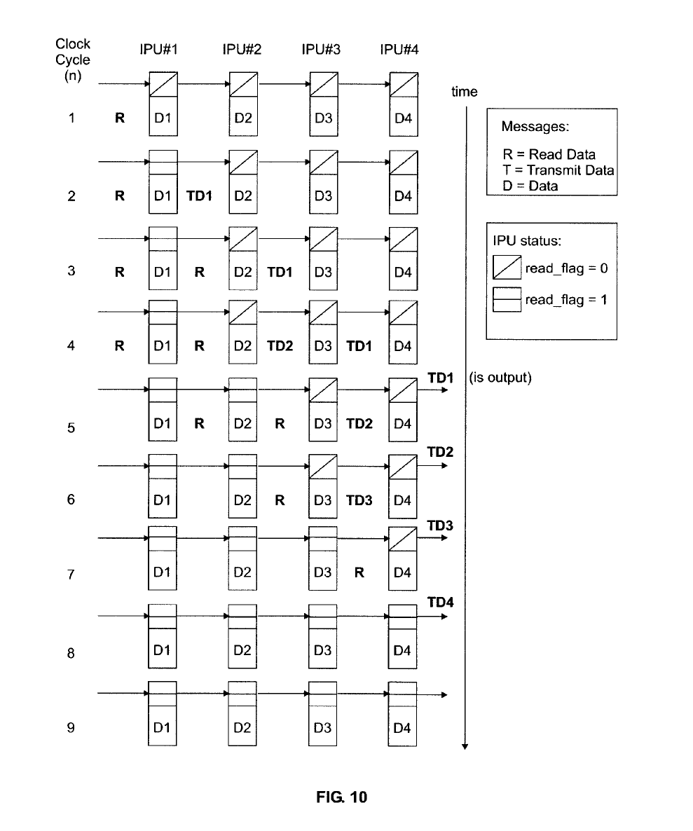

FIG. 10 illustrates another way of presenting the read operation described by reference to FIG. 9. The first row shows the four IPUs at the initial time, when the Read message is applied on the first IPU. The next row shows all IPUs a clock cycle after. The Read message is now transformed in a Transmit message which conveys the value read in the first IPU.

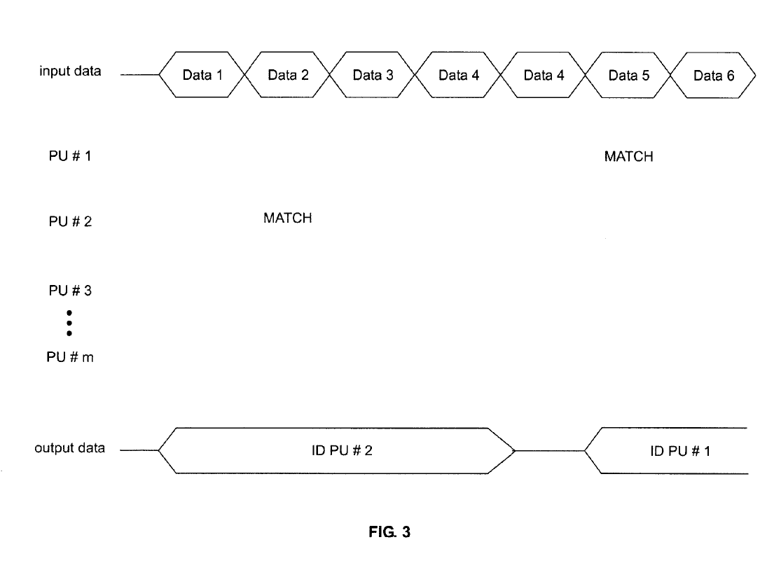

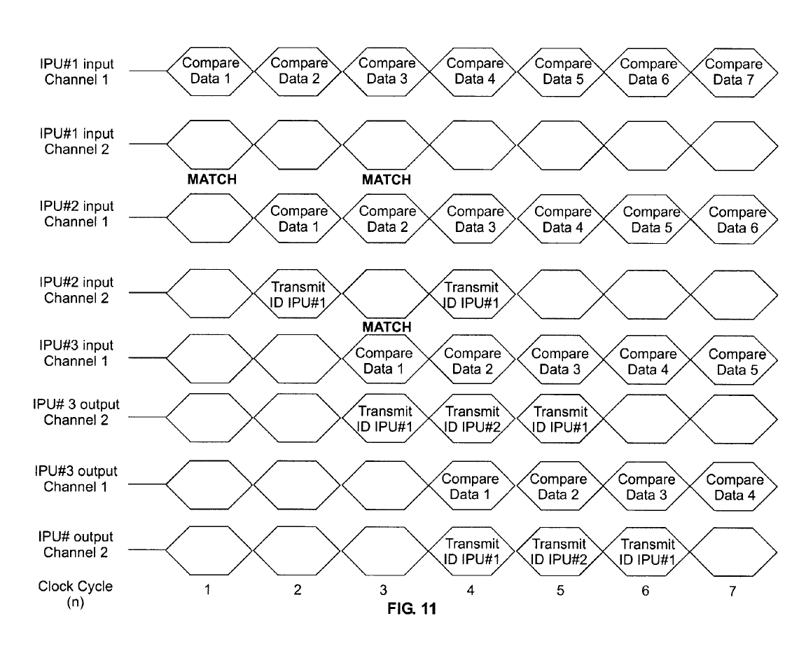

In an typical application to pattern recognition, each IPU of systems 34/41 makes a comparison between an input pattern and the stored reference pattern (or prototype) to detect if they are identical, i.e. a Match has occurred, or to give a distance to indicate their degree of similarity. FIG. 11 which shows the timing when the Exact Matching mode is used can be compared to FIG. 3.

Now turning to FIG. 1 1, the data to be compared are included in a stream of data that is continuously applied on Channel 1 of the first IPU of a group of three IPUs that have been previously initialized during the reference pattern store operation. Each IPU receives a message formed by an opcode Comp (compare) and a data (one or several bytes in one or several clock cycles), this message is transmitted from an IPU to the next one without any change. Each IPU compares the input data (received on Channel 1) with the prototype stored therein. Assuming there is a Match, the IPU sends a message to the next IPU (if not busy). Still referring to FIG. 11, during clock cycle 3, IPU#1 compares Data 3 and its own prototype, i.e. Prototype 1, and detects one Match (so that a message Transmit will be emitted one clock cycle later to transmit the ID of IPU#1. This message will travel through all remaining IPUs of the chain until it is received by the host. Simultaneously, let us assume IPU#2 also detects a Match between Data 2 and Prototype 2. One clock cycle later it will also send a Transmit message containing the ID of IPU#2. Still at the third clock cycle, IPU#3 compares Data 1 with Prototype 3; in this case, assuming no Match is detected, no message is generated. As a result, data to be compared travels via Channel 1 while the results, i.e. the ID of IPUs that have matched travels along Channel 2. The serial/parallel operation of the dual channel bus architecture of the present invention is thus clearly demonstrated.

Let us consider a typical scenario using the Exact Matching mode with an incoming data stream applied to a system comprised of s IPUs, each IPU being capable of storing t prototype components. The first phase consists in the initialization of the whole system, characterized by sending the message INIT. This message will initialize the flags stored in the above mentioned dedicated registers, e.g. set write_flag=‘0’ and the like. Then, the data (e.g. prototype components) and opcodes are stored using the following opcodes: SOP (store opcodes), SEL (store components in IPU memories, SST (store status) and SIDF (store ID and set write_flag=‘1’). These messages can be repeated a number of times for each IPU before considering the next IPU.

Now, the incoming data stream is sent by the host computer (one message for each input data). The following opcodes are used: COMP (compare components at each clock cycle), so that for each match occurring, opcode TID (Transmit ID) is sent in Channel 2.

In the case of a typical scenario using the Fuzzy Matching mode, when a considerable number of prototypes are stored in an external library, the initialization phase includes opcodes: INIT (to initialize all IPUs by setting the write_flag to ‘0’), SOPA (store the same component opcode in all opcode registers), and SSTA (store same control in all IPUs). Then, prototypes patterns must be stored in all IPUs, using opcodes: SEL (store component in memory, this is repeated t-1 times to store all the components, SELF (store a component in the memory and set write_flag to ‘1’ in other words loop on all prototypes in the library), COMP (compare component which is repeated t times), COMPL (compare last component for each IPU and read ID and distance), RID (read ID), RDISTF (read distances and set read_flag to ‘1’. As a consequence, for each RID input message, a message TID (transmit ID) is sent on Channel 2 and for each RDIST input message, a message TDIST (transmit distance) is sent on Channel 2.

Let us now consider a typical scenario for reading a component in a specific IPU having an ID. It relies on the following opcodes: SSTA (store same control in all IPUs, set read_flag to ‘1’ and write_flag to one plus mode

SELID (set read_flag to zero and write_flag to ‘1’ for IPUs having the ID equal to data), SETADR (set memory address for the first write_flag=‘0’), REL (read component for the first write_flag=‘0’) and TEL (generate transmit component).

The Table below shows a typical instruction list adapted to the dual channel bus architecture.

| | | Output | | | |
|---|---|---|---|---|---|
| | | message | | | |
| | | if | | | |
| Opcode/ | | process | | Process | Opcode |
| Alias | Description | (1) | Channel | Condition | type |
| NONE | No effect | NONE | 1 + 2 | | |
| INIT | Initialize all IPUs | INIT | | | |
| SJ | | NONE | | w_f = 0 | W |
| SJT | Store jump register in one IPU | SJT | 1 | | WA |
| | Store jump register In all IPUs | | | | |
| SOR | Store one instruction | NONE | 1 | w_f = 0 | W |
| SO | Store one component | NONE | | w_f = 0 | W |
| SOT | Store same opcode in all IPUs | SOT | | | WA |
| (SOPA) | Write register opcode in all IPUs | SOPA | 1 | | WA |
| /SORT | | | | | |
| SEL | Store component (write data and | SEL | 1 | w_f = 0 | W |
| | instructions) | | | | |
| SELO | Store only the data not the | NONE | 1 | w_f = 0 | W |
| | opcode (convolution) | | | | |
| SELOT | Store only the data in all IPUs | SELOT | 1 | w_f = 0 | WA |
| SELF | Write component + Set write_flag to | NONE | 1 | w_f = 0 | W |
| | 1 | | | | |
| SET | Store same component in all IPUs | SET | 1 | w_f = 0 | WA |
| SETF/ | Store same component in all IPUs + | SET | 1 | w_f = 0 | WA |
| SETW | write_flag = 1 | | | | |
| SIDF/ | Store ID in ID register + Set | WID | 2 | w_f = 0 | WA |
| WID | write_flag to 1 | | | | |
| SST | Store data in status register | NONE | 1 | w_f = 0 | W |
| SSTA | Store status in all IPUs (use to | SSTA | 1 | | WA |
| | reset flag) | | | | |
| SDIA/ | Store data in distance register | WDISTA | 2 | | WA |
| WDISTA | for all IPUs | | | | |
| SDI/WDIST | Store data in distance register | NONE | 2 | w_f = 0 | W |
| COMP/ (CI) | Compare input data | COMP | 1, 2 | | WA |
| | | | (out) | | |
| COMPL/ (CL) | Compare input data + | COMPL | 1, 2 | | WA |
| | last_component_flag = 1 | | (out) | | |
| UNSEL | Unselect IPU if dist not zero | UNSEL | 1 | | WA |
| | (If dist ! = 0) unselect_flag = 1 | | | | |
| SEL | Select all pu : unselect_flag = 0 | SEL | 1 | | WA |
| TID | Transmit ID (if data_flag = 1 (or | TID | 2 | | T |
| | transmit data instead) | | | | |
| CDIST | Compare distance if (data < dist) | CDSIT | 2 | | W |
| | {data_flag = 1; output2 = data2} else | | | | |
| | {data_flag = 0; output2 = dist} | | | | |
| TDIS | Transmit distance | TDIS | 2 | | T |
| RDIST | Read distance | NONE | 1, 2 | r_f = 0 | R |
| | | | (out) | | |
| RDISTF | Read distance + Set read-flag = 1 | NONE | 1, 2 | r_f = 0 | R |
| | | | (out) | | |
| RID | Read Id send a message with the | NONE | 1, 2 | r_f = 0 | R |
| | final id | | (out) | | |
| RIDF | Read ID + Set read-flag = 1 | NONE | 1, 2 | r_f = 0 | R |
| | | | (out) | | |
| OR | Logic OR : make a logic OR in all | OR | 1, 2 | | RA |
| | status registers | | (out) | | |

Notes
w_f = write flag and r_f = read flag
W = Write, WA = Write All, R = Read, RA = Read All, T = Transmit.

(1) If process condition is not verified, then the output opcode is the input opcode.

Process condition is applied only if an IPU is selected. If an IPU is not selected, this IPU performs no task and only transmits all input messages (only the Select II opcode re-selects an IPU).

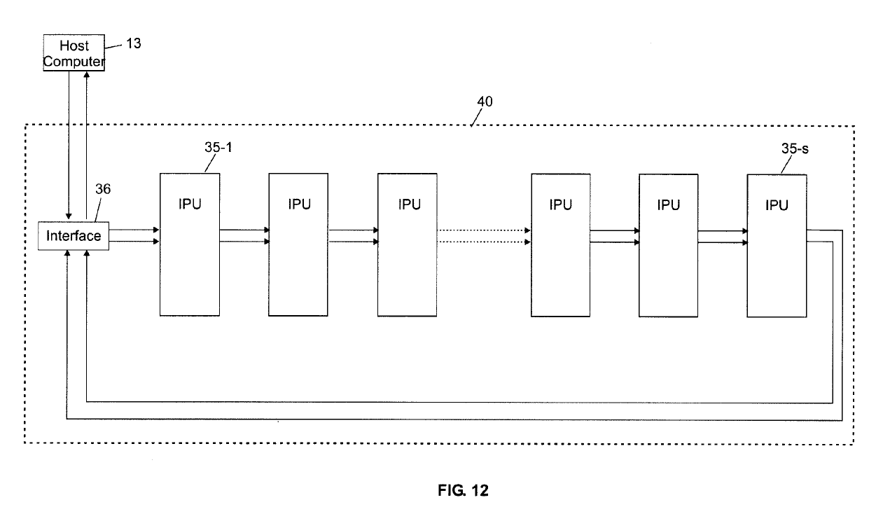

FIG. 12 shows a typical floor planning assembling all the IPUs of FIG. 5A (or FIG. 5B) when integrated in a semiconductor ASIC chip 40 (40′). As is apparent in FIG. 12, all IPUs 35(42)-1 to 35(42)-s form a chain wherein the connection between two adjacent IPUs, consists of the two buses Channel 1 and Channel 2. For each IPU, it is only needed to couple one IPU to the next one in a serial fashion. Adding IPUs thus only affects the wiring of an adjacent IPU. There is no longer the need to use additional circuit and an output bus, allowing thereby easy design, excellent scalability and reduced global wiring. The first IPU 35(42)-1 is connected to an input receiver (not shown) and the last IPU 35(42)-s is connected to an output driver (not shown) as standard.

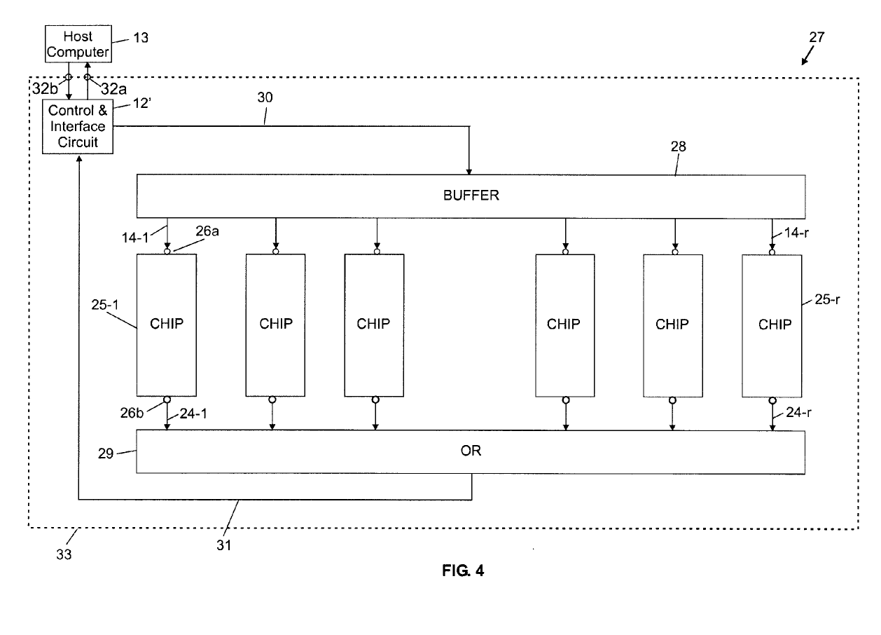

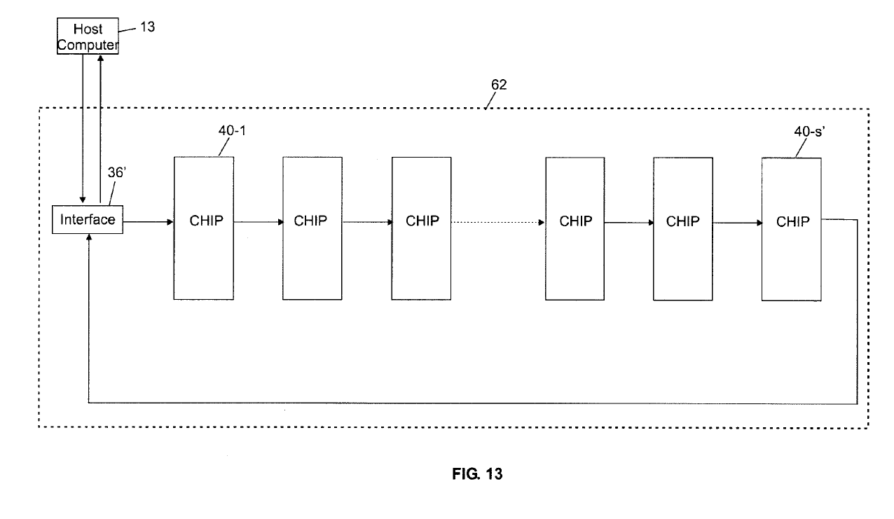

Should the IPUs 35(42)-1 to 35(42)-s replaced by semiconductor ASIC chips 40(40′), FIG. 12 would then represent an electronic card, as illustrated by card 62 in FIG. 13. The comparison with the design shown in FIG. 4 demonstrates that there is no longer any need to use the re-drive devices mentioned above (buffers and the tree of OR gates). Operating at very high frequencies is no longer a problem if card 62 is used, thanks to point to point connections.

Whether implementation is in chip 40 of FIG. 12 or card 62 of FIG. 13, it is clear that in both cases, the wiring is extremely simplified so that this design is easy to execute.

In summary, the advantages of the above-described dual channel bus architecture are the following:
(1) Different types of IPU can be used together, because only known messages are processed while unknown messages are transmitted to the next IPU.
(2) The circuitry area is reduced because no re-drive device is needed to distribute data.
(3) The wiring in the chip or in the card is reduced because there is only a local wiring between two adjacent IPUs.
(4) The power dissipation is reduced because there is no need for a clock tree distribution and data can be asynchronously processed.
(5) The speed is improved because only point to point links are required.
(6) The complexity of the chip/card design is reduced.

While the invention has been particularly described with respect to a preferred embodiment thereof it should be understood by one skilled in the art that the foregoing and other changes in form and details may be made therein without departing from the spirit and scope of the invention.

1. A processing unit comprising:
a processor configured to receive input data and to generate output data;
first and second input buses configured to convey an input message which includes an opcode with or without associated data;
first and second output buses configured to transmit an output message which includes an opcode with or without associated data; and
a message generator connected to said processor, to said first and second input buses and to said first and second output buses, said message generator being configured to decode said input message and to extract the opcode and any associated data therefrom, wherein said message generator receives said input message,
generates a first set of control data for input to said processor,
receives a second set of control data and data output by said processor, and
generates an output message on at least one of said first and said second output buses, the output message being in accordance with at least one of said input message and said second set of control data.

2. The processing unit of claim 1, wherein said message generator comprises:
a process condition unit configured to receive said input message and including at least one flag register, wherein depending on a flag value and the decoded opcode, said process condition circuit performs one of (1) generating a new message and (2) transmitting the input message as the output message.

3. The processing unit of claim 2, wherein said message generator further comprises a control unit connected to said processor, wherein
depending on a flag value, said control unit determines whether the input message must be executed by the processor.

4. The processing unit of claim 3, wherein in case the input message is not executed, the input message is transmitted as an output message without modification.

5. The processing unit of claim 1, wherein said message generator comprises:
a process condition unit configured to receive said input message and to determine whether said input message must be transmitted on said output buses without modification.

6. A system for transmitting data to a plurality of processing units, the system comprising:
a host computer;
an interface circuit having a bidirectional bus connected to the host computer to exchange data therewith;
a plurality of processing units serially connected to form a chain,
wherein each of said processing units comprises
a processor configured to receive input data and to generate output data;
first and second input buses configured to convey an input message which includes an opcode with or without associated data;
first and second output buses configured to transmit an output message which includes an opcode with or without associated data; and
a message generator connected to said processor, to said first and second input buses and to said first and second output buses, said message generator being configured to decode said input message and to extract the opcode and any associated data therefrom, wherein said message generator receives said input message,
generates a first set of control data for input to said processor,
receives a second set of control data and data output by said processor, and
generates an output message on at least one of said first and said second output buses, the output message being in accordance with at least one of said input message and said second set of control data;
and wherein the first and second input buses of a given processing unit not at an end of the chain are respectively connected to the first and second output buses of a previous processing unit, the first and second input buses of a first processing unit at one end of the chain being connected to said interface circuit and the first and second output buses of a last processing unit at the other end of the chain being connected to said interface circuit.

7. A method of processing a message including an opcode with or without associated data, the method comprising the steps of:
receiving an input message on at least one of a first input bus and a second input bus;
decoding the input message;
considering a process condition;
extracting the opcode and any associated data therefrom;
generating a first set of control data and data in accordance with said input message, depending upon said process condition;
processing said first set of control data to generate a second set of control data and data in accordance with said first set;
generating an output message in accordance with said input message and said second set of control data; and
transmitting said output message on at least one of a first output bus and a second input bus.

8. The method of claim 7 wherein said process condition is determined according to whether the opcode is valid.

9. The method of claim 8 wherein if the opcode is not valid, said step of processing is not performed and the input message is transmitted as the output message, and if the opcode is valid said step of processing is performed.

10. The method of claim 7, wherein said input message is received on the first input bus, and further comprising the steps of:
determining whether said output message must be transmitted on the second output bus; and
if yes and if the second output bus is not busy, transmitting said output message on said second output bus.

11. The method of claim 7, wherein said input message is received on the second input bus, and further comprising the steps of:
determining whether said output message must be transmitted on the first output bus; and
if yes and if the first output bus is not busy, transmitting said output message on said first output bus.
